(19) United States
(12) Patent Application Publication
(10) Pub. No.: US 2026/0141793 A1
(43) Pub. Date: May 21, 2026

(54) MOUNTING PLATE WITH INTEGRATED POWER SUPPLY

(71) Applicant: ADEMCO INC., Golden Valley, MN (US)

(72) Inventors: Travis Read, Little Canada (MN); Ryan Thorsen, Fergus Falls (MN); Pat Tessier, Maple Grove, MN (US); Steven Carlevato, Bolingbrook, IL (US)

(73) Assignee: RESIDEO LLC, Golden Valley, MN (US)

(21) Appl. No.: 19/127,190

(22) PCT Filed: Dec. 27, 2023
(86) PCT No.: PCT/US2023/086005

§ 371 Date: May 5, 2025

Related U.S. Application Data
(60) Provisional application No. 63/477,681, filed on Dec. 29, 2022.

(51) Int. Cl. G08B 17/113

(52) U.S. Cl. CPC G08B 17/113

(57) ABSTRACT

An apparatus can include a mounting plate comprising a housing with the mounting plate configured to be secured to a surface and configured to mount a home monitoring device. The apparatus can further include a power supply enclosed within the housing configured to receive AC power at an input, convert the AC power to a DC power, and output the DC power to the home monitoring device via two or more electrical contacts.

### RELATED APPLICATIONS

This Application claims the benefit of US Provisional Patent Application No. 63/477,681 filed Dec. 29, 2022, the contents of which are incorporated herein by reference.

### TECHNICAL FIELD

This disclosure generally relates to mounting plates.

### BACKGROUND

Mounting plates in homes and commercial spaces are commonly used to secure various devices to surfaces such that the devices can be mounted in desired locations and can be removed from the mounting plates if necessary. For instance, mounting plates are used to mount smoke detectors, thermostats, security cameras, and other monitoring devices to walls and ceilings of homes and commercial spaces. Most mounting plates are not standardized but are instead specific to an individual device. Further, devices that require power and are mounted to a surface using a mounting plate receive power from an internal power supply (i.e., battery) and/or from an external power source wired to the devices. Many such devices receive power from a building's mains power via wiring that may be exposed when connecting the devices to power. Wiring carrying mains power can be dangerous when exposed and professionals (i.e., electricians) are generally required to electrically connect devices to mains power.

### SUMMARY

This disclosure in general describes a mounting plate with an integrated power supply for mounting a home monitoring device to a surface. In particular, embodiments disclosed herein enable a home monitoring device to receive DC power directly from the mounting plate. Examples of home monitoring devices include smoke detectors, gas detectors, thermostats, security cameras, and other monitoring devices. Further, embodiments disclosed herein provide a mounting plate that does not expose wires or electrical contacts carrying mains power to users installing home monitoring devices. In one such example, the mounting plate includes a power supply that converts AC voltages to DC voltages and includes electrical contacts electrically connected to the DC portion of the power supply. The electrical contacts can electrically connect with a home monitoring device when the home monitoring device is mounted to the mounting plate and can provide the home monitoring device with DC power.

In a first aspect, an apparatus can include a mounting plate and a power supply. The mounting plate can include a housing. The mounting plate can be configured to be secured to a surface. The mounting plate can be configured to mount a home monitoring device (e.g., a hazard detector). The power supply can be enclosed within the housing.

The power supply can be configured to receive AC power at an input. The power supply can be configured to convert the AC power to DC power. The power supply can be configured to output the DC power to the home monitoring device (e.g., via two or more electrical contacts).

In some examples, the mounting plate may have various structural features. The mounting plate may be circular shaped. The housing may protrude rearward from the mounting plate. In some examples, the housing can include two or more electrical pins. The two or more electrical pins may be configured to accept a power plug. The two or more electrical pins can be electrically connected to the input of the power supply. In some examples, the mounting plate can include a continuous central surface that lacks a central opening.

In some examples, the two or more electrical contacts can be located proximate a center of the mounting plate. The two or more electrical contacts can protrude from a front face of the mounting plate. The front face can face away from the surface.

In some examples, the mounting plate comprises a ridge. The ridge can protrude from a front face of the mounting plate and surround the two or more electrical contacts. The two or more electrical contacts located on the front face of the mounting plate can be spring-loaded. In some examples, the two or more electrical contacts can be pogo-style electrical connectors.

In some examples, the housing can include wire connection ports. In some examples, the housing can define a first set of wire connection ports on a rear face of the housing. The housing can include a first set of clamping wire connectors within the first set of wire connection ports. The first set of clamping wire connectors can be electrically connected to the input of the power supply. The first set of clamping wire connectors can be configured to accept and secure corresponding ends of a first set of wires. In some examples, the housing can define a second set of wire connection ports on the rear face of the housing. The housing can include a second set of clamping wire connectors within the first set of wire connection ports. The second set of clamping wire connectors can be electrically connected to the first set of clamping wire connectors and/or the input of the power supply. The second set of clamping wire connectors can be configured to accept and secure corresponding ends of a second set of wires.

In a second aspect, a system includes a home monitoring device and a mounting plate. The home monitoring device can include mounting protrusions. The home monitoring device can include two or more home monitoring device electrical contacts. The mounting plate can be configured to secure to a surface. The home monitoring device can be configured to mount to the mounting plate. The mounting plate can include two or more mounting plate electrical contacts. The two or more mounting plate electrical contacts can be configured to electrically connect to the two or more home monitoring device electrical contacts when the home monitoring device is mounted to the mounting plate. The mounting plate can include a power supply. The power supply can be configured to receive AC power at an input. The power supply can be configured to convert the AC power to DC power. The power supply can be configured to output the DC power to the two or more mounting plate electrical contacts to power the home monitoring device.

In some examples, the home monitoring device can include a hazard detector. In some examples, the hazard detector can include a smoke detector. In some examples, the hazard detector can include a gas detector.

In some examples, spring-loaded electrical contacts are configured to mate with concentric ring electrical contacts. In some examples, the two or more mounting plate electrical contacts can be spring-loaded and protrude from a front face of the mounting plate, the front face facing away from the surface. The two or more home monitoring device electrical contacts can be arranged in two or more concentric rings. In some examples, the two or more home monitoring device electrical contacts can be spring-loaded and protrude from a rear face of the home monitoring device, the rear face facing toward the surface when the home monitoring device is mounted to the mounting plate. The two or more mounting plate electrical contacts are arranged in two or more concentric rings.

In a third aspect, a method may involve mounting a home monitoring device to a surface. The method can include securing a mounting plate to a surface. The mounting plate can include a power supply. The power supply can be configured to receive AC power at an input. The power supply can be configured to convert the AC power to DC power. The power supply can be configured to output the DC power to two or more mounting plate electrical contacts. The method can include mounting a home monitoring device to the mounting plate. The home monitoring device can include two or more home monitoring device electrical contacts. Mounting the home monitoring device to the mounting plate electrically can connect the two or more home monitoring device electrical contacts to the two or more mounting plate electrical contacts and enable the mounting plate to provide the DC power to the home monitoring device.

In some examples, mounting the home monitoring device to the mounting plate can include inserting a plurality of protrusions of the home monitoring device into a plurality of slots of the mounting plate and rotating the home monitoring device relative to the mounting plate. In some examples, any one of the plurality of protrusions of the home monitoring device can be inserted into any one of the plurality of slots of the mounting plate to electrically connect the two or more home monitoring device electrical contacts with the two or more mounting plate electrical contacts.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1A is a perspective view of a front face of an example mounting plate according to an aspect of the present disclosure.

FIG. 1B is a perspective view of a rear face of the example mounting plate of FIG. 1A.

FIG. 2 is a perspective view of a rear face of an alternate example mounting plate according to an aspect of the present disclosure.

FIG. 3 is a perspective view of an example mounting plate and an example home monitoring device according to an aspect of the present disclosure.

FIG. 4 is a flowchart diagram of an example method of mounting a home monitoring device to a surface using a mounting plate according to an aspect of the present disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

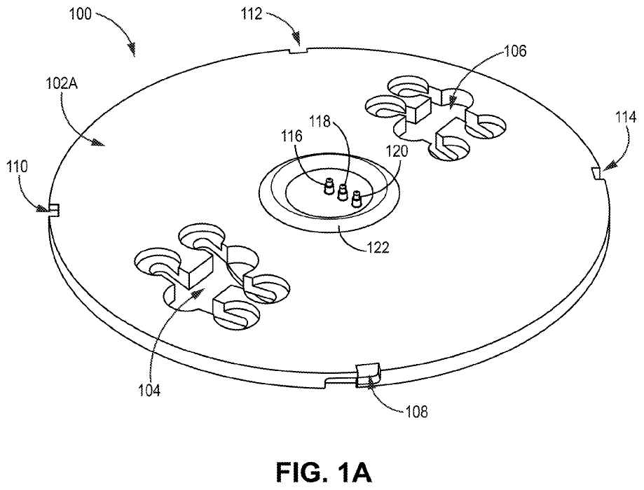

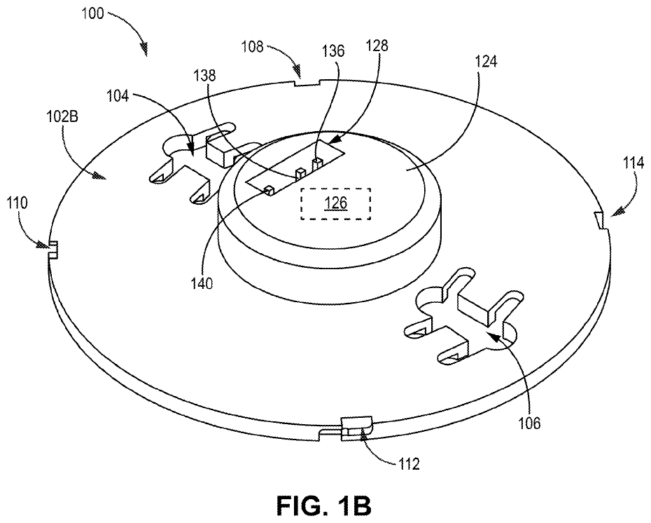

Starting with FIG. 1A and FIG. 1B, FIG. 1A illustrates one embodiment of a mounting plate 100 from a perspective view taken to show a front face 102A of the mounting plate 100 while FIG. 1B illustrates the embodiment of FIG. 1A from a perspective view taken to show a rear face 102B of the mounting plate 100. The mounting plate 100 is configured to secure to a surface and is further configured to mount a monitoring device to it. Additionally, the mounting plate is configured to receive AC power at an input, convert the AC power to DC power, and output the DC power to the home monitoring device via two or more electrical contacts.

The home monitoring device, which mounts to the mounting plate 100, can include many different devices. For instance, in some examples, the home monitoring device is a hazard detector. As used in this disclosure, a hazard detector includes, but is not limited to: smoke detectors (e.g., ionization, photoelectric), gas detectors (carbon monoxide, oxygen, propane gas, natural gas, and methane), heat detectors, and particulate detectors. Further, in some examples, a hazard detector can comprise more than one detector (e.g., smoke detector and carbon monoxide detector).

The mounting plate 100 of the illustrated embodiments is circular, however, the mounting plate can take any shape including a rectangular shape. As illustrated, the mounting plate 100 defines two fastener openings 104, 106, defines four slots 108, 110, 112, 114, includes three electrical contacts 116, 118, 120, and includes a ridge 122 that surrounds the three electrical contacts 116, 118, 120. The mounting plate also includes a housing 124 that houses a power supply 126 with three electrical pins 136, 138, 140 connected to the power supply 126. The two fastener openings 104, 106 are each configured to accept a fastener to secure the mounting plate 100 to a surface while the four slots 108, 110, 112, 114 are each configured to accept a protrusion of a home monitoring device to mount the home monitoring device to the mounting plate 100. The power supply 126 is configured to accept AC power at its input which comprises the three electrical pins 136, 138, 140 and is configured to output DC power at its output which comprises the three electrical contacts 116, 118, 120. The three electrical contacts 116, 118, 120 are configured to electrically connect with a home monitoring device mounted to the mounting plate 100 and provide the DC power to the home monitoring device while the ridge 122 is configured to help protect the three electrical contacts 116, 118, 120 from physical damage.

In the embodiment of FIG. 1A, the two fastener openings 104, 106 defined by the mounting plate 100 are each shaped with a large central opening connecting to four smaller openings that branch out from the large central opening. The four smaller openings each have a corresponding recessed portion defined by the mounting plate 100 that is centered around them at an end. The large central opening is sized to allow a head of a fastener to pass through it while the four smaller openings are sized to allow a shaft of a fastener to pass through them. If a shaft of a fastener passes through one of the four smaller openings, the head of the fastener can engage and possibly become flush with the front face 102A of the mounting plate 100 due to the corresponding recessed portion. Each of the two fastener openings 104, 106 accepts one fastener to secure the mounting plate 100 to a surface. However, the size and shape of the two fastener openings 104, 106 enable a corresponding fastener to secure in any one of the four smaller openings with the recessed portion.

The two fastener openings 104, 106 are used when securing the mounting plate 100 to a surface. The surface can be any surface including a ceiling, wall, or a surface of another structure. For instance, in some examples, a box (e.g., electrical box, junction box) is connected to a surface and includes portions to which fasteners can secure. In some such examples, a fastener can be secured to the box through each large central opening of the two fastener openings 104, 106 and the mounting plate 100 can be secured to the fasteners by rotating the mounting plate 100 relative to the surface. In rotating the mounting plate relative to the surface, the shafts of the fasteners can each fit into a corresponding one of the four smaller openings with the head of the fasteners fitting into a recessed portion. The fasteners can be tightened such that their heads engage the corresponding recessed portions of the mounting plate 100. Alternatively, in some examples, fasteners can already be secured to a box connected to a surface but have a portion, which includes their head, protruding from the box. In some such examples, the mounting plate 100 can be secured to the box by aligning the heads of the fasteners into the large central openings of the two fastener openings 104, 106 and subsequently rotating the mounting plate 100 relative to the surface such that the shafts of the fasteners enter the corresponding smaller openings.

The combination of the large central opening with the four smaller openings for each of the two fastener openings 104, 106 as illustrated in the embodiment of FIG. 1A enables the mounting plate 100 to be secured to different sized boxes (e.g., electrical boxes, junction boxes) and/or to different spacings of fasteners. For instance, the four smaller openings of one such fastener opening are in two sets of two with each set being at different radii from a center of the mounting plate. This configuration enables the mounting plate to secure to differently sized boxes and/or different spacings of fasteners because a shaft of a fastener can pass through a smaller opening of one of the two sets of smaller openings which are at different radii. Further, because a set of two smaller openings are located the same radius from the center of the mounting plate but are on either side of the central opening, the mounting plate can be rotated relative to a surface either clockwise or anti-clockwise and still secure to the surface with the corresponding fasteners. In general, the two fastener openings 104, 106 enable the mounting plate to be more universal in its securing to a surface and other structures (e.g., box). While two fastener openings are described, the mounting plate 100 can include any number of fastener openings (e.g., two or more).

While the two fastener openings 104, 106 of FIG. 1A/B are used in securing the mounting plate 100 to a surface or box, a person having ordinary skill in the art will appreciate that other structures for securing the mounting plate 100 to a surface or box are contemplated and that this disclosure is not limited to any one structure or method. For instance, some non-limiting examples include the mounting plate defining openings having any shape for fasteners to pass through and secure to a surface, the mounting plate being secured to a surface using adhesives instead of fasteners, and the mounting plate being secured to a surface with clips not requiring fastener holes.

Continuing with FIG. 1A, the mounting plate 100 defines four slots 108, 110, 112, 114 which are used to receive corresponding protrusions from a home monitoring device to mount the home monitoring device to the mounting plate 100. The four slots 108, 110, 112, 114, each contain an entry portion and a locking portion. The entry portion enables a corresponding protrusion to be inserted while the locking portion prevents the corresponding protrusion from being pulled out. In the illustrated example, the locking portion and the entry portion of each slot are separated by a detent that resists the protrusion of the home monitoring device from moving from the locking portion to the entry portion. In mounting a home monitoring device to the mounting plate 100, each of the four slots 108, 110, 112, 114 receive a corresponding protrusion of the home monitoring device at the entry portion. Subsequently, the home monitoring device can be rotated relative to the mounting plate 100 and the protrusions of the home monitoring device will move from the entry portion to the locking portion and secure the home monitoring device to the mounting plate. In removing the home monitoring device from the mounting plate 100, the home monitoring device can be rotated relative to the mounting plate 100 in a direction opposite of that used to mount the home monitoring device to the mounting plate 100. The protrusions of the home monitoring device will engage the detents of the corresponding slots and resist rotation, but the resistance can be overcome such that the protrusions rotate to the entry portion from the locked portion. Thus, the protrusions can be pulled out of the slots to remove the home monitoring device from the mounting plate 100. The arrangement of the four slots 108, 110, 112, 114 are such that a user can align any two protrusions of the home monitoring device with the corresponding two slots and the rest of the protrusions and slots will also be aligned. While four slots 108, 110, 112, 114 are described, any number of slots can be used (e.g., two or more).

Now referring to both FIG. 1A and FIG. 1B, the mounting plate 100 includes a housing 124 located on a rear face 102B of the mounting plate 100. The housing 124 protrudes rearward from the rear face 102B of the mounting plate 100. However, in some examples, the housing 124 protrudes frontward from the front face 102A. The housing 124 houses a power supply 126 inside and can also house other electronics. The power supply 126 is electrically connected to the three electrical contacts 116, 118, 120 illustrated in FIG. 1A and is further electrically connected to three electrical pins 136, 138, 140. In the embodiment of FIG. 1A/B, the electrical pins 136, 138, 140 are electrically connected to a first side of the power supply 126 (e.g., input) while the electrical contacts 116, 118, 120 are electrically connected to a second side (e.g., output) of the power supply 126. In operation, the power supply can receive AC power from the electrical pins 136, 138, 140, convert the power to DC power, and output the DC power to the electrical contacts 116, 118, 120. The electrical contacts 116, 118, 120 can provide the DC power to a home monitoring device that is mounted to the mounting plate.

Continuing with the power supply 126, the power supply 126 performs AC power to DC power conversion and can be configured to receive/output specified voltages and/or specified ranges of voltages. The power supply 126 can receive AC power at a mains voltage or multiple mains voltages. For instance, in some embodiments, the power supply 126 can accept AC power at 120V while in some embodiments, the power supply 126 can accept AC power at 220V. In some examples, the power supply 126 can accept both AC power at 120V and AC power at 220V. For instance, the power supply can detect a mains voltage and use different electronics to perform power conversion. Further, in some embodiments, the power supply can receive AC power at different frequencies and convert the AC power to a DC power. In general, the power supply 126 can convert AC power at a small range of mains voltages (e.g., 110V-120V, 220V-240V) to DC power at a specified voltage. The specified voltage can be based on voltage requirements of electronics connected to the power supply such as a home monitoring device. For instance, some common specified voltage can be 3V, 5V, 9V, and 12V. The power supply 126 can use any type of AC to DC power conversion and is not limited to any one type of AC to DC converter.

In the embodiment of FIG. 1A/B, the power supply 126 is connected to the electrical pins 136, 138, 140, which can constitute an input of the power supply 126, and is further connected to the electrical contacts 116, 118, 120, which can constitute an output of the power supply 126. The electrical pins 136, 138, 140 can be wired to mains AC power with each electrical pin connected to a wire of the mains AC power. For instance, in some examples, a first electrical pin is connected to a line wire, a second electrical pin is connected to a neutral wire, and a third electrical pin is connected to a ground wire. However in some examples, the third electrical pin is not connected to ground, but is instead connected to a communication wire. While three electrical pins 136, 138, 140 are illustrated in FIG. 1A/1B, in some examples, only two or more are used. For example, a first pin can be connected to a line wire while a second pin can be connected to a neutral wire.

In some examples, the mounting plate 100 includes two sets of electrical pins with each set containing two or more electrical pins. In some such examples, one set of electrical pins can be connected to mains power wires while another set of electrical pins can be connected to electrical pins of a different mounting plate. Alternatively, in some such examples, one set of electrical pins is connected to electrical pins of a second mounting plate while one set of electrical pins are connected to electrical pins of a third mounting plate. Examples with one set of electrical pins connected to another mounting plate can enable multiple mounting plates to be powered on a single circuit.

In some examples, in order to connect electrical pins (e.g., 136, 138, 140) with mains power, a power plug is used. In such examples, the power plug can comprise holes that correspond to the electrical pins and which enclose the electrical pins. Further, the housing 124 of the mounting plate can define an opening 128 that is sized to accept the power plug. The power plug can be electrically connected to mains power wires such that when the power plug is inserted into the opening and the holes of the power plug enclose the electrical pins, the electrical pins are in electrical communication with the mains power wires.

Continuing with the electrical contacts 116, 118, 120, the electrical contacts 116, 118, 120 are located proximate a center of the mounting plate 100. As best seen in FIG. 1A, a first electrical contact 116 is located most proximate the center, a second electrical contact 118 is located slightly further away from the center, and a third electrical contact 120 is located furthest from the center relative to the other electrical contacts. As described previously, the electrical contacts 116, 118, 120 are electrically connected to the power supply 126 and can provide power to a device connected to them such as a home monitoring device. In similarity with the electrical pins 136, 138, 140, the electrical contacts 116, 118, 120 can have a first electrical contact as a line contact, a second electrical contact as a neutral/return contact, and a third electrical contact as a ground contact. In some examples, the third electrical contact is a communication contact. Further, in some examples, only two electrical contacts are used with one contact being line and one contact being a neutral/return. In some examples, the number of electrical contacts corresponds to the number of electrical pins.

As illustrated in FIG. 1A, the electrical contacts 116, 118, 120 generally protrude outward from the front face 102A of the mounting plate 100 and can, in some examples, protrude slightly further out from the front face 102A than the ridge 122 which surrounds them. The electrical contacts 116, 118, 120 in the embodiment of FIG. 1A/1B are also spring-loaded pogo-style contacts which enable them to retract when contacted, but still electrically connect to the thing they are contacting.

The electrical contacts, though, can take many different forms and are not limited to spring-loaded contacts nor pogo-style contacts. For instance, in some examples, the electrical contacts comprise concentric circles of electrically conductive material. In some such examples, the concentric circles of electrically conductive material can be substantially flat. In similarity with the embodiment of FIG. 1A/B, the concentric circles of electrically conductive material can include a first electrical contact proximate a center of the mounting plate, a second electrical contact slightly further away from the center of the mounting plate, and a third electrical contact further away from the center of the mounting plate than the other electrical contacts. Additionally, in such examples, no ridge (e.g., 122) surrounding the electrical contacts may be needed to protect the electrical contacts from damage.

In comparison with many traditional mounting brackets, the mounting bracket of FIG. 1A/1B does not define a large opening in its center. Instead, the mounting bracket has a continuous central surface lacking any large openings. Many traditional mounting brackets require a large opening at their center to allow wiring to be pulled through with the wiring used to connect a device being mounting to the mounting bracket to power. However, the example mounting bracket of FIG. 1A/B has wiring connected to its power supply 126 in the housing 124 protruding from the rear face 102B of the mounting plate 100. By not defining a large opening in its center, the mounting bracket of FIG. 1A/B can prevent dust and other debris from falling through such an opening. This can be advantageous as dust and other debris may collect over time and interact poorly with a device, such as a hazard detector, mounted to the mounting plate.

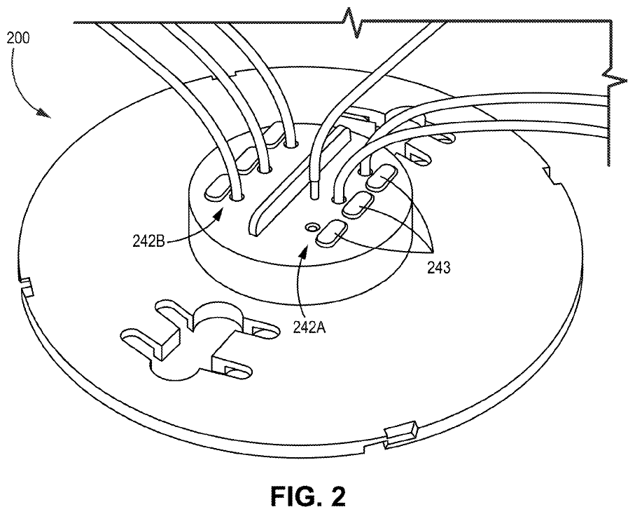

Moving to FIG. 2, FIG. 2 is a perspective view of a rear face of an alternate example mounting plate 200 according to an aspect of the present disclosure. In contrast to the example mounting plate illustrated in FIG. 1B, the example mounting plate of FIG. 2 includes a first set of wire connection ports 242A and a second set of wire connection ports 242B. The first set of wire connection ports 242A is labeled “line” and can be electrically connected to mains power while the second set of wire connection ports 242B is labeled “load” and can be electrically connected to a load such as another mounting plate. However, in some examples, the first set of wire connection ports 242A can be connected to a second mounting plate and the second set of wire connection ports 242B can be connected to a third mounting plate. Both configurations, though, provide the ability for multiple mounting brackets to be on the same electrical circuit.

The first set of wire connection ports 242A and the second set of wire connection ports 242B each contain three ports which can be used for a line wire, a neutral wire, and a ground or communication wire. The first set of wire connection ports 242A includes a corresponding first set of clamping wire connectors inside the first set of wire connection ports 242A. The first set of clamping wire connectors are electrically connected to an input of the power supply and can exert a force on an inserted wire to secure the wire and prevent it from coming out. Similarly, the second set of wire connection ports 242B includes a corresponding second set of clamping wire connectors inside the second set of wire connection ports 242B. The second set of clamping wire connectors are electrically connected to an input of the power supply and/or to the first set of clamping wire connectors and can also exert a force on an inserted wire to secure the wire and prevent it from coming out. In some examples, the first set of clamping wire connectors and the second set of clamping wire connectors are spring loaded such that they compress on a wire when it is inserted. In some such examples, a push button (e.g., 243) can be used to reduce the compression of an inserted wire to enable the inserted wire to be pulled out when necessary.

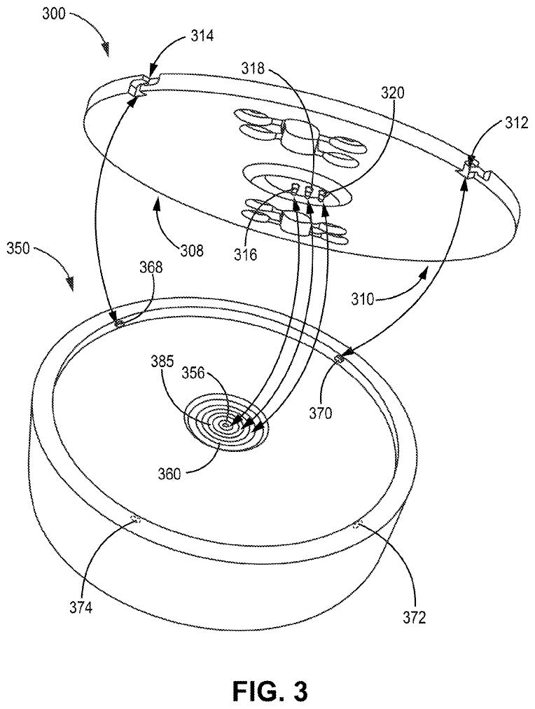

Moving to FIG. 3, FIG. 3 is a perspective view of an example mounting plate 300 and an example home monitoring device 350 according to an aspect of the present disclosure. In the illustrated example, the mounting plate 300 is secured to a surface and includes a power supply for converting AC power to DC power. The mounting plate 300 also includes mounting plate electrical contacts 316, 318, 320 which are electrically connected to the power supply. The power supply can receive AC power at an input (e.g., electrical pins 136, 138, 140) and can output DC power to the mounting plate electrical contacts 316, 318, 320.

The mounting plate 300 also includes four slots 308, 310, 312, 314 and the home monitoring device includes four corresponding protrusions 368, 370, 372, 374. As described elsewhere herein, the home monitoring device 350 can be mounted to the mounting plate 300 by aligning at least two of the four protrusions 368, 370, 372, 374 with the corresponding at least two of the four slots 308, 310, 312, 314 and rotating the home monitoring relative to the mounting plate 300. For example, in the illustrated embodiment, a first protrusion 368 and a second protrusion 370 of the home monitoring device 350 can be aligned with a first slot 308 and a second slot 310. Once aligned, the home monitoring device 350 can be brought toward the mounting plate 300 such that the four protrusions 368, 370, 372, 374 are inserted into entry portions of the four slots 308, 310, 312, 314. Once the four protrusions 368, 370, 372, 374 are inserted, the home monitoring device 350 is rotated relative to the mounting plate 300 such that the four protrusions 368, 370, 372, 374 move into locking portions of the four slots 308, 310, 312, 314. In some examples, the locking portions of the four slots are separated from the entry portions of the four slots by detents which can help ensure the home monitoring device 350 does not easily rotate out of the four slots 308, 310, 312, 314.

Continuing with FIG. 3, the home monitoring device 350 also includes three home monitoring device electrical contacts 356, 358, 360. The three home monitoring device electrical contacts 356, 358, 360 can be electrically connected to electronics within the home monitoring device. In the illustrated embodiment, the three home monitoring device electrical contacts 356, 358, 360 comprise three concentric circles which are substantially flat. However, in some examples, the home monitoring device comprises electrical contacts that are spring loaded and protrude from the home monitoring device. For instance, the home monitoring device can include electrical contacts that are pogo-style, spring-loaded electrical contacts such as the three mounting plate electrical contacts 316, 318, 320. Accordingly, in some such embodiments, the corresponding mounting plate electrical contacts can include concentric rings of electrical contacts. Such a configuration comprises the reverse of the illustrated configuration of electrical contacts in FIG. 3.

Both the illustrated configuration of electrical contacts of FIG. 3 and the reverse of the illustrated configuration of electrical contacts of FIG. 3 have advantages over other configurations. One such advantage is that no matter the orientation of the home monitoring device 350 relative to the mounting plate 300, as long as the home monitoring device 350 is mounted to the mounting plate 300, the home monitoring device electrical contacts will be in electrical communication with the mounting bracket electrical contacts. For example, a first 368 and second protrusion 370 of the home monitoring device 350 can be mounted to the first 308 and second slot 310, the second 310 and third slot 312, the third 312 and fourth slot 314, or the fourth 314 and first slot 308 and the home monitoring device electrical contacts 356, 358, 360 will be in electrical communication with the mounting plate electrical contacts 316, 318, 320. As the number and location of protrusions and slots can also vary, the home monitoring device can effectively receive DC power from the mounting plate regardless of the orientation of the home monitoring device relative to the mounting plate so long as the home monitoring device is mounted to the mounting plate.

In the illustrated embodiment of FIG. 3, a first home monitoring device electrical contact 356 is located proximate a center of the home monitoring device, a second home monitoring device electrical contact 358 is located slightly further from the center of the home monitoring device 350, and a third home monitoring device electrical contact 360 is located the furthest away from the center of the home monitoring device relative to the other home monitoring device electrical contacts. While three home monitoring device electrical contacts are illustrated, in some embodiments, the home monitoring device can include two or more home monitoring device electrical contacts. For instance, in similarity with the electrical pins in the example of FIG. 1B, one home monitoring device electrical contact can be used for a line connection while one home monitoring device electrical contact can be used for a neutral/return connection. However, in embodiments where three home monitoring device electrical contacts are used, the third home monitoring device electrical contact can be a ground or communication connection.

Further in FIG. 3, the three mounting plate electrical contacts 316, 318, 320 are spring loaded with a first mounting plate electrical contact 316 located proximate a center of the mounting plate 300, a second mounting plate electrical contact 318 located slightly further from the center of the mounting plate 300, and a third mounting plate electrical contact 320 located the further away from the center of the mounting plate relative to the other mounting plate electrical contacts. While three mounting plate electrical contacts are illustrated, in some embodiments, the mounting plate can include two or more mounting plate electrical contacts. For instance, in similarity with the electrical pins in the example of FIG. 1B, one mounting plate electrical contact can be used for a line connection while one mounting plate electrical contact can be used for a neutral/return connection. In embodiments where three mounting plate electrical contacts are used, the third mounting plate electrical contact can be a ground or communication connection.

In the illustrated embodiment, the three home monitoring device electrical contacts 356, 358, 360 are located approximately the same distance from a center of the home monitoring device 350 as the three mounting plate electrical contacts 316, 318, 320 are from a center of the mounting plate 300. Additionally, the center of the home monitoring device 350 can align with a center of the mounting plate 300 when the home monitoring device is secured to the mounting plate 300 (e.g., via the protrusions and slots discussed elsewhere herein). Accordingly, as indicated by the arrows, each home monitoring device electrical contact aligns with, and contacts, a corresponding mounting plate electrical contact when the home monitoring device 350 is mounted to the mounting plate 300. The home monitoring device electrical contacts 356, 358, 360 can compress the mounting plate electrical contacts 316, 318, 320 and ensure proper electrical contact therebetween. Thus, the home monitoring device electrical contacts 356, 358, 360 can be in electrical communication with the mounting plate electrical contacts 316, 318, 320. As the mounting plate electrical contacts 316, 318, 320 are electrically connected to a power supply that outputs DC power, the mounting plate 300 can provide DC power to the home monitoring device 350 to power the home monitoring device when the home monitoring device 350 is mounted to the mounting plate 300.

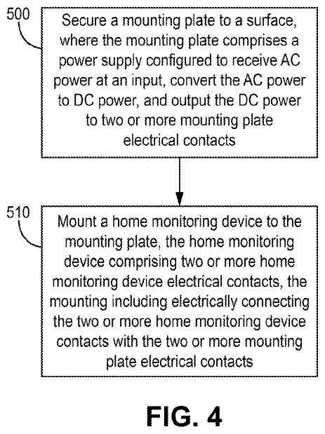

Moving to FIG. 4, FIG. 4 is a flowchart diagram of an example method of mounting a home monitoring device to a surface using a mounting plate according to an aspect of the present disclosure. The method starts with securing a mounting plate to a surface where the mounting plate comprises a power supply configured to receive AC power at an input, convert the AC power to DC power, and output the DC power to two or more mounting plate electrical contacts as in step 500. The method further includes mounting a home monitoring device to the mounting plate with the home monitoring device comprising two or more home monitoring device electrical contacts as in step 510. Further, mounting the home monitoring device to the mounting plate electrically connects the two or more home monitoring device electrical contacts to the two or more mounting plate electrical contacts and enables the mounting plate to provide DC power to the home monitoring device. In some examples, mounting a home monitoring device to a mounting plate includes inserting a plurality of protrusions of the home monitoring device into a plurality of slots of the mounting plate and rotating the home monitoring device relative to the mounting plate. In some such examples, any one of the plurality of protrusions of the home monitoring device can be inserted into any one of the plurality of slots of the mounting plate to electrically connect the two or more home monitoring device electrical contacts with the two or more mounting plate electrical contacts.

Various examples have been described. These and other examples are within the scope of the following claims.

1. An apparatus comprising:
a mounting plate comprising a housing, the mounting plate configured to be secured to a surface and configured to mount a home monitoring device; and
a power supply enclosed within the housing and configured to receive AC power at an input, convert the AC power to DC power, and output the DC power to the home monitoring device via two or more electrical contacts.

2. The apparatus of claim 1, wherein the home monitoring device comprises a hazard detector.

3. The apparatus of claim 1, wherein the two or more electrical contacts are located proximate a center of the mounting plate and protrude from a front face of the mounting plate, the front face facing away from the surface.

4. The apparatus of claim 1, wherein the mounting plate comprises a ridge protruding from a front face of the mounting plate and surrounding the two or more electrical contacts.

5. The apparatus of claim 3, wherein the two or more electrical contacts located on the front face of the mounting plate are spring-loaded.

6. The apparatus of claim 5, wherein the two or more electrical contacts are pogo-style electrical connectors.

7. The apparatus of claim 1, w herein the mounting plate is circular shaped.

8. The apparatus of claim 1, wherein the housing protrudes rearward from the mounting plate.

9. The apparatus of claim 1, wherein the housing defines a first set of wire connection ports on a rear face of the housing, the housing further comprising a first set of clamping wire connectors within the first set of wire connection ports, the first set of clamping wire connectors electrically connected to the input of the power supply and configured to accept and secure corresponding ends of a first set of wires.

10. The apparatus of claim 9, wherein the housing defines a second set of wire connection ports on the rear face of the housing, the housing further comprising a second set of clamping wire connectors within the first set of wire connection ports, the second set of clamping wire connectors electrically connected to the first set of clamping wire connectors and/or the input of the power supply and configured to accept and secure corresponding ends of a second set of wires.

11. The apparatus of claim 1, wherein the housing comprises two or more electrical pins configured to accept a power plug, the two or more electrical pins electrically connected to the input of the power supply.

12. The apparatus of claim 1, wherein the mounting plate comprises a continuous central surface that lacks a central opening.

13. A system comprising:
a home monitoring device comprising mounting protrusions and two or more home monitoring device electrical contacts; and a mounting plate configured to secure to a surface, the home monitoring device configured to mount to the mounting plate, the mounting plate comprising: two or more mounting plate electrical contacts configured to electrically connect to the two or more home monitoring device electrical contacts when the home monitoring device is mounted to the mounting plate; and
a power supply configured to receive AC power at an input, convert the AC power to DC power, and output the DC power to the two or more mounting plate electrical contacts to power the home monitoring device.

14. The system of claim 13, wherein the home monitoring device comprises a hazard detector.

15. The system of claim 14, wherein the hazard detector comprises a smoke detector.

16. The system of claim 14, wherein the hazard detector comprises a gas detector.

17. The system of claim 13, wherein: the two or more mounting plate electrical contacts are spring-loaded and protrude from a front face of the mounting plate, the front face facing away from the surface; and the two or more home monitoring device electrical contacts are arranged in two or more concentric rings.

18. The system of claim 13, wherein: the two or more home monitoring device electrical contacts are spring-loaded and protrude from a rear face of the home monitoring device, the rear face facing toward the surface when the home monitoring device is mounted to the mounting plate; and the two or more mounting plate electrical contacts are arranged in two or more concentric rings.

19. A method of mounting a home monitoring device to a surface comprising:
securing a mounting plate to a surface, the mounting plate comprising a power supply configured to receive AC power at an input, convert the AC power to DC power, and output the DC power to two or more mounting plate electrical contacts: and
mounting a home monitoring device to the mounting plate, the home monitoring device comprising two or more home monitoring device electrical contacts, wherein mounting the home monitoring device to the mounting plate electrically connects the two or more home monitoring device electrical contacts to the two or more mounting plate electrical contacts and enables the mounting plate to provide the DC power to the home monitoring device.

20. The method of claim 19, wherein mounting the home monitoring device to the mounting plate comprises inserting a plurality of protrusions of the home monitoring device into a plurality of slots of the mounting plate and rotating the home monitoring device relative to the mounting plate, wherein any one of the plurality of protrusions of the home monitoring device can be inserted into any one of the plurality of slots of the mounting plate to electrically connect the two or more home monitoring device electrical contacts with the two or more mounting plate electrical contacts.

21. (canceled)
